(19) United States
(12) Patent Application Publication
(10) Pub. No.: US 2020/0247043 A1
(43) Pub. Date: Aug. 6, 2020

(54) THREE-DIMENSIONAL SHAPING DEVICE AND SHAPING METHOD FOR THREE-DIMENSIONAL SHAPED OBJECT

(71) Applicant: SEIKO EPSON CORPORATION, Tokyo (JP)

(72) Inventor: Toshihisa SARUTA, Matsumoto (JP)

(21) Appl. No.: 16/775,357

(22) Filed: Jan. 29, 2020

(30) Foreign Application Priority Data
Jan. 31, 2019 (JP) 2019-015048

(51) Int. Cl. B29C 64/165; B29C 64/264; B29C 64/209; B22F 3/00; B33Y 10/00; B33Y 30/00

(52) U.S. Cl. CPC B29C 64/165; B29C 64/264; B33Y 30/00; B22F 3/008; B33Y 10/00; B29C 64/209

(57) ABSTRACT

A three-dimensional shaping device includes: a discharge unit in which a plurality of nozzles are arranged along a first direction and which discharges a liquid from the nozzle toward a stage; a main moving unit that changes a relative position between the discharge unit and the stage in a second direction intersecting the first direction; and a control unit that, while changing the relative position between the discharge unit and the stage along the second direction by controlling the discharge unit and the main moving unit, repeats a processing of forming a shaping layer by discharging the liquid from the nozzle, to shape a laminated body in which the shaping layers are laminated. The control unit causes a relative position between the stage and the nozzle, from which the liquid is discharged, to be changed in the first direction when forming one of the shaping layers and when forming another layer of the shaping layers.

The present application is based on, and claims priority from JP Application Serial Number 2019-015048, filed Jan. 31, 2019, the disclosure of which is hereby incorporated by reference herein in its entirety.

### BACKGROUND

### 1. Technical Field

The present disclosure relates to a three-dimensional shaping device and a shaping method for a three-dimensional shaped object.

### 2. Related Art

For example, JP-A-2018-154047 discloses a device that shapes a three-dimensional shaped object in which a powder layer is formed by spreading a powder and then a liquid binding agent for binding the powder is discharged to a specified region of the powder layer to shape a layered structure, and the layered structure is subjected to the above operations to laminate a plurality of the layered structures. In this device, the binding agent is discharged from a plurality of nozzles arranged side by side.

With the above device, a space may occur in the layered structure due to variations in discharge characteristics of each nozzle discharging the binding agent. For example, when a landing position of the binding agent deviates from an intended position, or when the binding agent is not discharged to the intended position due to clogging of the nozzle, a space occurs. When spaces overlap in a lamination direction, strength of the three-dimensional shaped object may decrease. This problem is not limited to a binding agent injection system that shapes a three-dimensional shaped object by discharging a liquid binding agent from a nozzle, and is also common to a material injection system that shapes a three-dimensional shaped object by discharging a liquid material from a nozzle. Therefore, the present application provides a technique for preventing a decrease in strength of a three-dimensional shaped object.

### SUMMARY

According to one aspect of the present disclosure, a three-dimensional shaping device is provided. The three-dimensional shaping device includes: a discharge unit in which a plurality of nozzles are arranged along a first direction and which discharges a liquid from the nozzles toward a stage; a main moving unit that changes a relative position between the discharge unit and the stage in a second direction intersecting the first direction; and a control unit that, while controlling the discharge unit and the main moving unit to change the relative position between the discharge unit and the stage along the second direction, repeats executing processing of forming a shaping layer by discharging the liquid from the nozzle, to shape a laminated body in which the shaping layers are laminated. The control unit causes the relative position between the stage and the nozzle, from which the liquid is discharged, to be changed in the first direction, when forming one layer of the shaping layers and when forming another layer of the shaping layers.

### BRIEF DESCRIPTION OF THE DRAWINGS

FIG. 1 is a first illustrative diagram illustrating a schematic configuration of a three-dimensional shaping device according to a first embodiment.

FIG. 2 is a second illustrative diagram illustrating the schematic configuration of the three-dimensional shaping device according to the first embodiment.

FIG. 3 is an illustrative diagram illustrating an arrangement of nozzle holes at an overlap portion.

FIG. 4 is a block diagram illustrating a configuration of a control unit according to the first embodiment.

FIG. 5 is an illustrative diagram illustrating a table for conversion to shaping data according to the first embodiment.

FIG. 6 is a flowchart illustrating contents of a shaping processing according to the first embodiment.

FIG. 7 is a first time chart illustrating a data signal for forming an odd-numbered layer.

FIG. 8 is a first time chart illustrating a data signal for forming an even-numbered layer.

FIG. 9 is a second time chart illustrating a data signal for forming an odd-numbered layer.

FIG. 10 is a second time chart illustrating a data signal for forming an even-numbered layer.

FIG. 11 is an illustrative diagram schematically illustrating a cross section of a three-dimensional shaped object according to the first embodiment.

FIG. 12 is an illustrative diagram schematically illustrating a cross section of a three-dimensional shaped object according to a comparative example.

FIG. 13 is an illustrative diagram illustrating a schematic configuration of a three-dimensional shaping device according to a second embodiment.

FIG. 14 is a block diagram illustrating a configuration of a control unit according to the second embodiment.

FIG. 15 is a first illustrative diagram illustrating a table for conversion to shaping data according to the second embodiment.

FIG. 16 is a second illustrative diagram illustrating the table for conversion to the shaping data according to the second embodiment.

FIG. 17 is a flowchart illustrating contents of a shaping processing according to the second embodiment.

### DESCRIPTION OF EXEMPLARY EMBODIMENTS

### A. First Embodiment

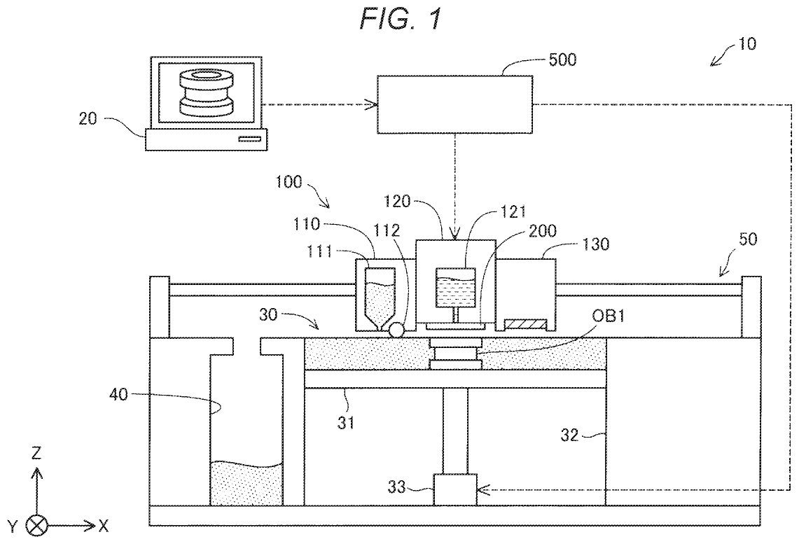

FIG. 1 is a first illustrative diagram illustrating a schematic configuration of a three-dimensional shaping device 10 according to a first embodiment. FIG. 1 schematically illustrates the three-dimensional shaping device 10 and a three-dimensional shaped object OB1 shaped by the three-dimensional shaping device 10 that are viewed from the side. In FIG. 1, arrows along X, Y, and Z directions which are orthogonal to each other are illustrated. The X direction and the Y direction are directions along a horizontal direction, and the Z direction is a direction along a vertical direction. In other drawings, the arrows along the X, Y, and Z directions are illustrated as appropriate. The X, Y, and Z directions in FIG. 1 indicate the same directions as the X, Y, and Z directions in the other figures indicate. The Y direction may be referred to as a first direction, and the X direction may be referred to as a second direction.

The three-dimensional shaping device 10 includes a shaping tank part 30, a shaping unit 100, a main moving unit 50, and a control unit 500. An information processing device 20 is connected to the control unit 500. The three-dimensional shaping device 10 and the information processing device 20 can also be combined and regarded as a three-dimensional shaping device in a broad sense.

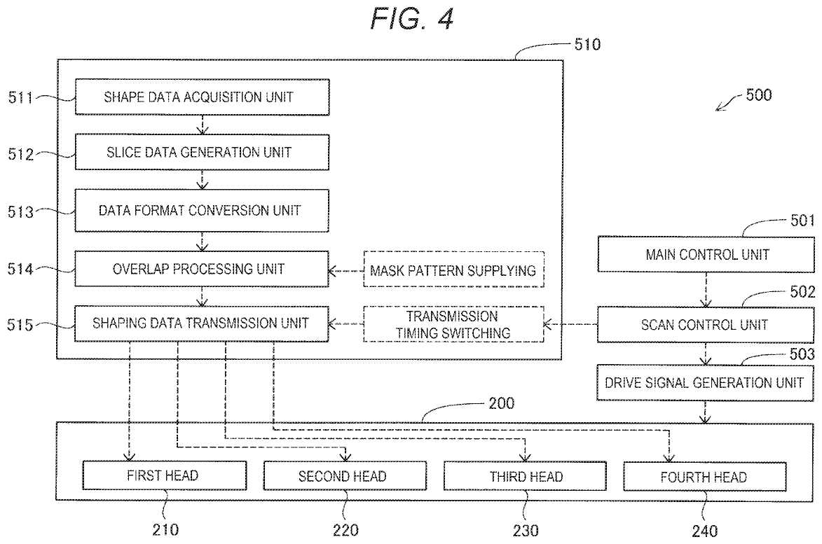

The control unit 500 is implemented by a computer that includes one or more processors, a main storage device, and an input/output interface for inputting and outputting signals from and to the outside. In the present embodiment, the control unit 500 executes a shaping processing for shaping the three-dimensional shaped object OB1, which will be described below, by the processor executing a program or a command read on the main storage device. The control unit 500 may be implemented by a combination of a plurality of circuits instead of a computer. A more specific configuration of the control unit 500 will be described below with reference to FIG. 4.

The shaping tank part 30 is a tank-shaped structure body in which the three-dimensional shaped object OB1 is shaped. The shaping tank part 30 includes a planar stage 31 along the X and Y directions, a frame body 32 surrounding an outer periphery of the stage 31, and an elevating mechanism 33 configured to move the stage 31 along the Z direction. The stage 31 is moved along the Z direction in the frame body 32 by the control unit 500 controlling operations of the elevating mechanism 33.

The main moving unit 50 is provided above the shaping tank part 30. The main moving unit 50 changes a relative position between the shaping unit 100 and the stage 31 along the X direction. In the present embodiment, the main moving unit 50 is implemented by an actuator for moving the shaping unit 100 along the X direction. The main moving unit 50 may change the relative position between the shaping unit 100 and the stage 31 along the X direction by moving the stage 31 along the X direction, or may change the relative position between the shaping unit 100 and the stage 31 along the X direction by moving both the shaping unit 100 and the stage 31.

The shaping unit 100 is supported by the main moving unit 50 and is provided above the shaping tank part 30. In the present embodiment, the shaping unit 100 includes a powder layer forming unit 110, a discharge unit 120, and a curing energy supply unit 130. The shaping unit 100, while being moved above the stage 31 along the X direction, forms a powder layer above the stage 31 by using the powder layer forming unit 110, discharges a binding liquid, which is a liquid containing a binding agent, onto the powder layer by using the discharge unit 120 to form a shaping layer, and cures the binding agent by using the curing energy supply unit 130. By repeating the above operations by the shaping unit 100, the three-dimensional shaped object OB1 in which shaping layers are laminated is shaped. The shaping layer is a part corresponding to one layer of the three-dimensional shaped object OB1. The three-dimensional shaped object OB1 may be referred to as a laminated body.

The powder layer refers to a layer obtained by spreading a powder, which is a powder-like material of the three-dimensional shaped object OB1. Various materials such as a metal material, a ceramic material, a resin material, a composite material, wood, rubber, leather, carbon, glass, a biocompatible material, a magnetic material, gypsum, and sand can be used as the powder. One type of these materials may be used as the powder, or two or more types thereof may be used in combination as the powder. In the present embodiment, powder-like stainless steel is used as the powder.

The binding agent has a function of binding powders. The binding agent not only binds the powders in the same shaping layer, but also binds the powder spread on the shaping layer with the shaping layer. Therefore, adjacent shaping layers are bound with each other. A thermoplastic resin, a thermosetting resin, an X-ray curable resin, various photo-curable resins including a visible light curable resin cured by light in a visible light region, an ultraviolet curable resin and an infrared curable resin, or the like can be used as the binding agent. One type of these resins may be used as the binding agent, or two or more types thereof may be used in combination as the binding agent. In the present embodiment, a thermosetting binding agent is used.

The powder layer forming unit 110 includes a powder supply unit 111 and a planarizing unit 112. The powder supply unit 111 supplies the powder onto the stage 31. In the present embodiment, the powder supply unit 111 is implemented by a hopper in which the powder is stored. The planarizing unit 112, while being moved above the stage 31 along the X direction, forms a powder layer above the stage 31 by planarizing the powder supplied from the powder supply unit 111. The powder pushed out from the stage 31 by the planarizing unit 112 is evacuated into a powder recovery part 40 provided adjacent to the shaping tank part 30. In the present embodiment, the planarizing unit 112 is implemented by a roller. It should be noted that the planarizing unit 112 may be implemented by a squeegee.

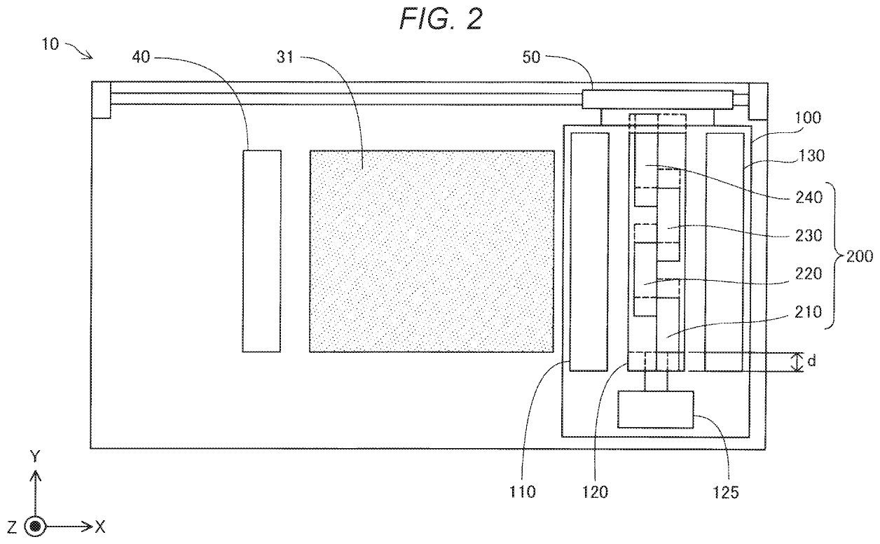

The discharge unit 120 includes a liquid supply unit 121 and a line head 200. The liquid supply unit 121 supplies the binding liquid to the line head 200. In the present embodiment, the liquid supply unit 121 is implemented by a tank in which the binding liquid is stored. The line head 200, while being moved above the stage along the X direction, discharges the binding liquid supplied from the liquid supply unit 121 toward the powder layer formed above the stage 31. A more specific configuration of the discharge unit 120 will be described below with reference to FIG. 2.

The curing energy supply unit 130 supplies energy for curing the binding agent to the binding agent contained in the binding liquid discharged from the discharge unit 120 to the powder layer. In the present embodiment, the curing energy supply unit 130 is implemented by a heater. In the present embodiment, since a thermosetting binding agent is used, the curing energy supply unit 130 cures the binding agent by heating with the heater. When a photo-curable binding agent is used, the curing energy supply unit 130 may cure the binding agent by irradiating the binding agent with corresponding light. For example, when an ultraviolet curable binding agent is used, the curing energy supply unit 130 may be implemented by an ultraviolet lamp.

FIG. 2 is a second illustrative diagram illustrating the schematic configuration of the three-dimensional shaping device 10 according to the first embodiment. FIG. 2 schematically illustrates the three-dimensional shaping device 10 as viewed from above. A specific configuration of the discharge unit 120 will be described with reference to FIG. 2. In the present embodiment, as described above, the line head 200 is provided in the discharge unit 120. Further, a sub moving unit 125 is provided in the discharging unit 120.

The line head 200 is implemented by connecting a plurality of liquid discharge heads. Each of the liquid discharge heads is implemented by a liquid discharge head of a piezo driving type. In the liquid discharge head of a piezo driving type, a pressure chamber provided with fine nozzle holes is filled with a binding liquid and a side wall of the pressure chamber is bent by using a piezo element, thereby making it possible to discharge the binding liquid, as droplets, in a volume equivalent to a volume decrease of the pressure chamber. The nozzle hole may be referred to as a nozzle.

In the present embodiment, the line head 200 is implemented by connecting four liquid discharge heads along the Y direction. The respective liquid discharge heads are referred to as a first head 210, a second head 220, a third head 230, and a fourth head 240 in this order from one end portion of the line head 200. Among the heads 210 to 240, adjacent ones partially overlap with each other in the X direction.

The sub moving unit 125 changes a relative position between the line head 200 and the stage 31 in the Y direction. In the present embodiment, the sub moving unit 125 is implemented by an actuator for moving the line head 200 along the Y direction. In FIG. 2, a position of the line head 200 after being moved by the sub moving unit 125 is indicated by broken lines. The sub moving unit 125 may change the relative position between the line head 200 and the stage 31 in the Y direction by moving the entire shaping unit 100. In addition, the sub moving unit 125 may change the relative position between the line head 200 and the stage 31 in the Y direction by moving the stage 31, or may change the relative position between the line head 200 and the stage 31 in the Y direction by moving both the line head 200 and the stage 31.

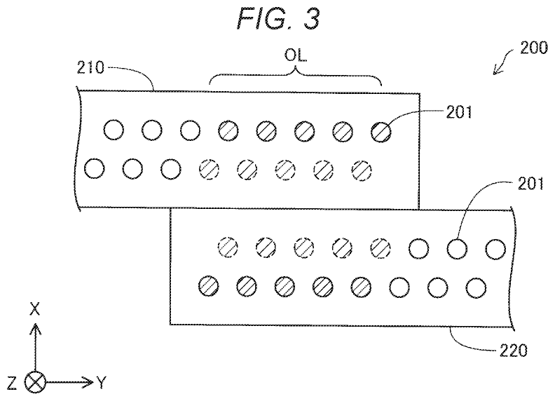

FIG. 3 is an illustrative diagram illustrating an arrangement of nozzle holes 201 at an overlap portion OL. FIG. 3 illustrates an overlap portion OL between the first head 210 and the second head 220 of the line head 200 as viewed from below. The overlap portion OL refers to a region, of the adjacent heads 210 and 220, where portions in which the nozzle holes 201 are provided overlap with each other in the X direction. The overlap portion OL may be referred to as an overlapping region. In FIG. 3, the nozzle holes 201 arranged in the overlap portion OL are hatched. In FIG. 3, nozzles to be used to be described below are indicated by solid lines, and nozzles not to be used are indicated by broken lines.

In the present embodiment, a plurality of nozzle holes 201 from which the binding liquid is discharged as droplets are provided in a staggered arrangement on lower surfaces of the respective heads 210 to 240. That is, two nozzle rows composed of a plurality of nozzle holes 201 arranged at equal intervals are provided in parallel on the lower surfaces of the respective heads 210 to 240. The nozzle rows are arranged to be deviated from each other along an arrangement direction of the nozzle holes 201. Magnitude of the deviation is the same as a distance of one half of the interval between the nozzle holes 201 in the same nozzle row. In the present embodiment, the nozzle row is arranged along the Y direction. At the overlap portion OL, the nozzles to be used and the nozzles not to be used are set by an overlap processing to be described below such that the liquid droplets do not discharged from both of the heads 210 and 220 to the same position repeatedly.

FIG. 4 is a block diagram illustrating a configuration of the control unit 500 according to the present embodiment. The control unit 500 includes a main control unit 501, a scan control unit 502, a drive signal generation unit 503, and a shaping data generation unit 510. The main control unit 501 controls the entire three-dimensional shaping device 10. The scan control unit 502 controls the shaping unit 100. The drive signal generation unit 503 supplies to the line head 200 a drive signal for discharging the binding liquid as droplets.

The shaping data generation unit 510 includes a shape data acquisition unit 511, a slice data generation unit 512, a data format conversion unit 513, an overlap processing unit 514, and a shaping data transmission unit 515.

The shape data acquisition unit 511 acquires shape data indicating a shape of the three-dimensional shaped object OB1. For example, data that is prepared by using three-dimensional CAD software or three-dimensional CG software and that is output in STL format, IGES format, or STEP format can be used as the shape data. In the present embodiment, the shape data acquisition unit 511 acquires the shape data from the information processing device 20 connected to the three-dimensional shaping device 10. The acquired shape data is transmitted to the slice data generation unit 512. The shape data acquisition unit 511 may acquire the shape data via a recording medium such as a USB memory.

The slice data generation unit 512 generates a plurality of pieces of cross section data of the three-dimensional shaped object OB1 by using the shape data. The slice data generation unit 512 cuts the shape of the three-dimensional shaped object OB1 at intervals corresponding to a thickness of one layer of the three-dimensional shaped object OB1 to be shaped on the stage 31, so as to generate the plurality of pieces of cross section data. The slice data generation unit 512 further uses the generated cross section data to generate dot data for each layer, which indicates the amount of liquid droplets to be discharged with respect to coordinates in the X direction and the Y direction. The generated dot data for each layer is transmitted to the data format conversion unit 513.

The data format conversion unit 513 generates line data in which the dot data for each layer is rearranged according to a formation order of the line head 200. The generated line data is transmitted to the overlap processing unit 514.

The overlap processing unit 514 performs an overlap processing using the line data and previously stored mask patterns, so as to generate the shaping data to be used at the time of discharging the droplets from the heads 210 to 240. The overlap processing is a processing of setting the nozzles to be used and the nozzles not to be used at the overlap portion OL of the line head 200. The nozzle to be used refers to a nozzle hole 201 not prohibited from discharging the droplets, and the nozzle not to be used refers to a nozzle hole 201 prohibited from discharging the droplets.

In the present embodiment, mask patterns for the respective heads 210 to 240 are stored in a storage device of the control unit 500. A mask pattern for the first head 210 is referred to as a first mask pattern, a mask pattern for the second head 220 is referred to as a second mask pattern, a mask pattern for the third head 230 is referred to as a third mask pattern, and a mask pattern for the fourth head 240 is referred to as a fourth mask pattern. The mask patterns are set such that the nozzles to be used and the nozzles not to be used are alternately arranged. The generated shaping data is transmitted to the shaping data transmission unit 515. As described above, in FIG. 3, the nozzles to be used are indicated by solid lines, and the nozzles not to be used are indicated by broken lines.

The shaping data transmission unit 515 transmits the shaping data to the heads 210 to 240 of the line head 200. In the present embodiment, the shaping data transmission unit 515 transmits the shaping data to the heads 210 to 240, by serial transfer according to a cycle of moving the line head 200 in the X direction.

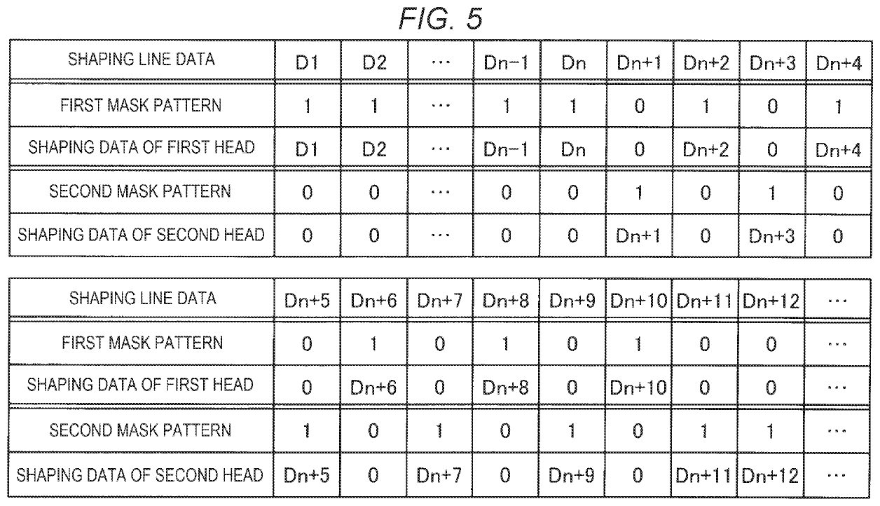

FIG. 5 is an illustrative diagram illustrating a table for conversion to shaping data according to the present embodiment. In FIG. 5, as an example, a table for conversion in the vicinity of the overlap portion OL of the first head 210 and the second head 220 is shown. In the mask patterns of the heads 210 to 240, a value of “1” is set for the nozzle to be used, and a value of “0” is set for the nozzle not to be used. By multiplying the line data by a value indicated by the first mask pattern and by multiplying the line data by a value indicated by the second mask pattern, the line data is allocated to the first head 210 and the second head 220, and shaping data of the first head 210 and shaping data of the second head 220 are generated.

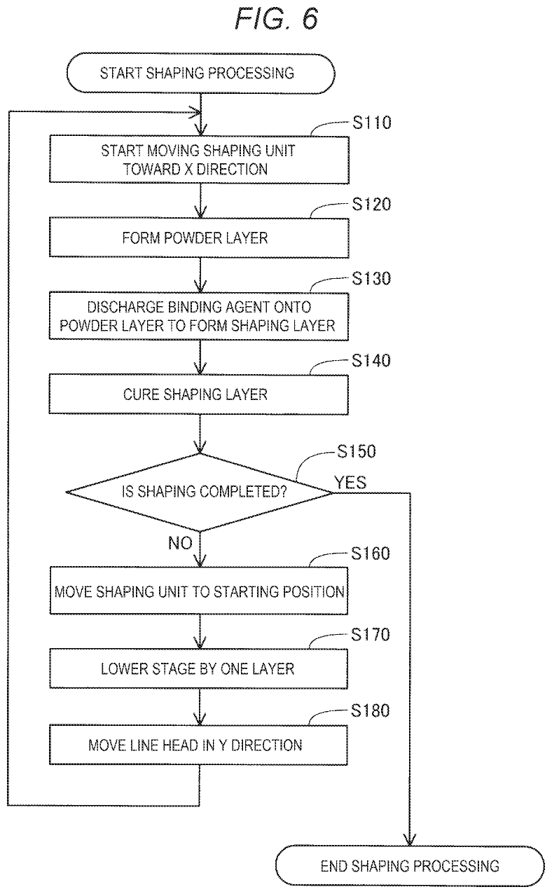

FIG. 6 is a flowchart illustrating contents of a shaping processing for realizing shaping of the three-dimensional shaped object OB1 according to the present embodiment. This processing is executed by the control unit 500 when a predetermined start operation is performed, by a user, on an operation panel provided in the three-dimensional shaping device 10 or on the information processing device 20 connected to the three-dimensional shaping device 10.

First, in step S110, the control unit 500 controls the main moving unit 50 to start moving the shaping unit 100 toward the X direction. In the present embodiment, the control unit 500 causes the shaping unit 100 to move from the right end to the left end of the stage 31 in FIG. 2.

Next, in step S120, the control unit 500 controls the powder layer forming unit 110 of the shaping unit 100 to form a powder layer above the stage 31. In step S130, the control unit 500 controls the discharge unit 120 of the shaping unit 100 to discharge droplets of the binding liquid onto the powder layer to form a shaping layer. In step S140, the control unit 500 controls the curing energy supply unit 130 of the shaping unit 100 to cure the binding agent contained in the binding liquid. From step S110 to step S140, while the shaping unit 100 is being moved above the stage 31 from the right end to the left end, a single layer of the shaping layer is formed.

Thereafter, in step S150, the control unit 500 determines whether the shaping of the three-dimensional shaped object OB1 is completed. The control unit 500 can use the shaping data to determine whether the shaping of the three-dimensional shaped object OB1 is completed. When it is determined in step S150 that the shaping of the three-dimensional shaped object OB1 is not completed, the control unit 500 controls, in step S160, the main moving unit 50 to move the shaping unit 100 from the left end to the right end of the stage 31 in FIG. 2. In step S170, the control unit 500 controls the elevating mechanism 33 to lower the stage 31 by a distance equal to the thickness of the shaping layer. In step S180, the control unit 500 controls the sub moving unit 125 to move the line head 200 in the Y direction. In the present embodiment, the control unit 500 causes the line head 200 to be moved by a distance equal to a length of the overlap portion OL. Thereafter, the processing is returned to step S110 to form another shaping layer above the shaping layer. On the other hand, when it is determined in step S150 that the shaping of the three-dimensional shaped object OB1 is completed, the control unit 500 ends this processing.

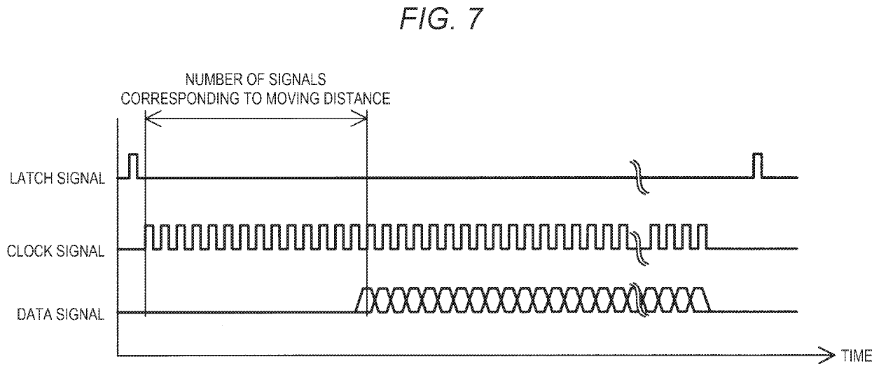

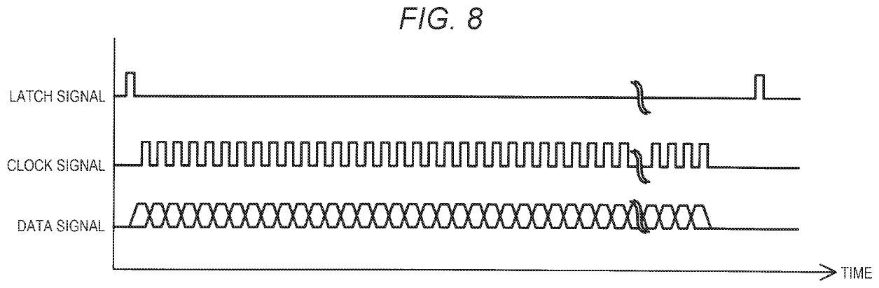

FIG. 7 is a time chart illustrating a data signal of the shaping data which is transmitted from the shaping data transmission unit 515 to the first head 210 when forming an odd-numbered shaping layer. FIG. 8 is a time chart illustrating a data signal of the shaping data which is transmitted from the shaping data transmission unit 515 to the first head 210 when forming an even-numbered shaping layer. The data signal is a signal indicating presence/absence of droplets discharged from the nozzle hole 201.

As shown in FIG. 7, when forming an odd-numbered shaping layer, the shaping data transmission unit 515 transmits, after a latch signal indicating the start of data, a data signal to the first head 210 at a timing when a predetermined number of clock signals are counted. The number of the predetermined clock signals may be the number of clock signals corresponding to a moving distance of the line head 200 from a position at the time of forming an odd-numbered shaping layer to a position at the time of forming an even-numbered shaping layer. On the other hand, as shown in FIG. 8, when forming an even-numbered shaping layer, the shaping data transmission unit 515 transmits a data signal to the first head 210 without counting the predetermined number of clock signals. That is, the shaping data transmission unit 515 delays the timing of transmitting the data signal to the first head 210 in the case of forming an odd-numbered shaping layer, as compared to the case of forming an even-numbered shaping layer.

The shaping data transmission unit 515 changes the timing of transmitting the data signal to change the nozzle holes 201, from which the droplets of the binding liquid are discharged, when forming an odd-numbered shaping layer and when forming an even-numbered shaping layer. The shaping data transmission unit 515 changes the nozzle holes 201, from which the droplets are discharged, to nozzle holes 201 arranged at a distance equal to the moving distance of the line head 200, in a direction opposite to a moving direction of the line head 200. Therefore, the deviation is prevented, which occurs accompanying the movement of the line head 200 and between an end portion of an odd-numbered shaping layer in the Y direction and an end portion of an even-numbered shaping layer in the Y direction.

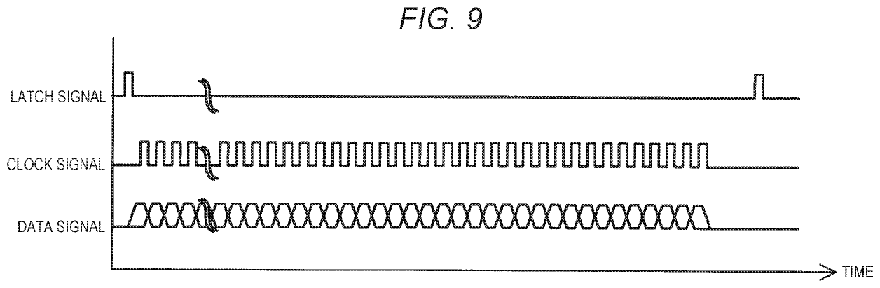

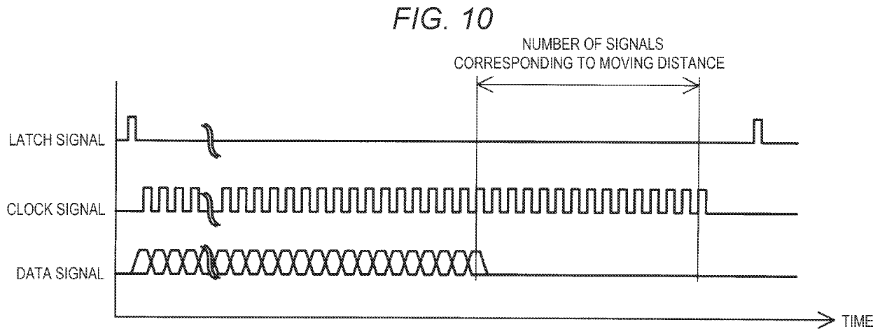

FIG. 9 is a time chart illustrating a data signal of the shaping data which is transmitted from the shaping data transmission unit 515 to the fourth head 240 when forming an odd-numbered shaping layer. FIG. 10 is a time chart illustrating a data signal of the shaping data which is transmitted from the shaping data transmission unit 515 to the fourth head 240 when forming an even-numbered shaping layer. As shown in FIGS. 9 and 10, the shaping data transmission unit 515 delays the timing of transmitting the data signal to the fourth head 240 in the case of forming an odd-numbered shaping layer, as compared to the case of forming an even-numbered shaping layer.

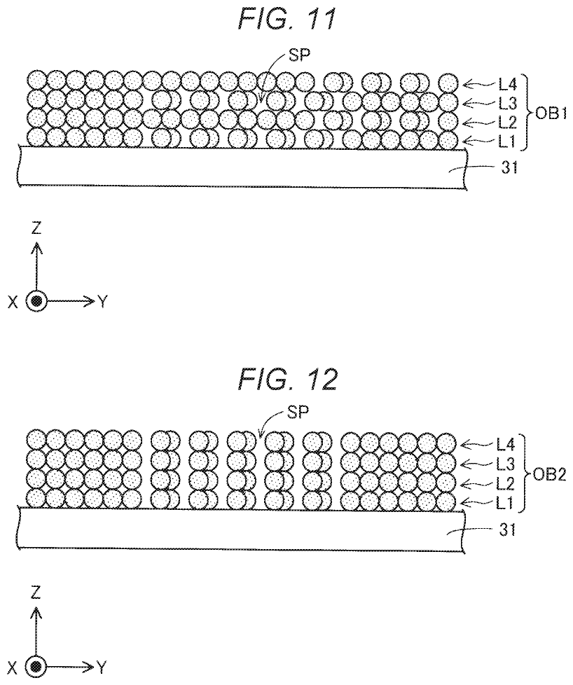

FIG. 11 is an illustrative diagram schematically illustrating a cross section of the three-dimensional shaped object OB1 shaped by the shaping processing according to the present embodiment. As shown in FIG. 11, a space SP occurs in the three-dimensional shaped object OB1. The space SP occurs when a landing position of the droplets of the binding liquid deviates from an intended position. The deviation of the landing position of the droplets is caused by, for example, an assembly error at the time of connecting the heads 210 to 240, or variations in discharge characteristics of the droplets from the nozzle holes 201. In addition, occurrence of the space SP may be caused by, for example, no discharge of the droplets from the nozzle holes 201 to the intended position due to clogging of the nozzle holes 201.

In the present embodiment, as described above, the control unit 500 controls the sub moving unit 125 to change the relative position between the line head 200 and the stage 31 in the Y direction, in other words, to change in the Y direction the relative position between the nozzle hole 201, from which the droplets are discharged, and the stage 31, when shaping a first layer L1 and a third layer L3 that are odd-numbered layers of the three-dimensional shaped object OB1 and when shaping a second layer L2 and a fourth layer L4 that are even-numbered layers of the three-dimensional shaped object OB1. In the present embodiment, the control unit 500 changes in the Y direction, by a distance equal to the length of the overlap portion OL, the relative position between the nozzle holes 201, from which the droplets are discharged, and the stage 31. Therefore, positions of the spaces SP of the first layer L1 and the third layer L3, and positions of the spaces SP of the second layer L2 and the fourth layer L4, are different in the Y direction by the distance equal to the length of the overlap portion OL. That is, in the present embodiment, the positions of the spaces SP in the three-dimensional shaped object OB1 are dispersed without overlapping each other in the lamination direction.

FIG. 12 is an illustrative diagram schematically illustrating a cross section of a three-dimensional shaped object OB2 as a comparative example. The three-dimensional shaped object OB2 of the comparative example is shaped without changing the relative position in the Y direction between the nozzle holes 201, from which the droplets are discharged, and the stage 31. Therefore, the positions of the spaces SP from the first layer L1 to the fourth layer L4 are the same in the Y direction. That is, in the comparative example, the positions of the spaces SP in the three-dimensional shaped object OB2 overlap with each other in the lamination direction.

According to the three-dimensional shaping device of the present embodiment described above, the three-dimensional shaped object OB1, in which the position of the space SP in the odd-numbered shaping layer and the position of the space SP in the even-numbered shaping layer are dispersed without overlapping with each other in the lamination direction, can be shaped by the control unit 500 causing to change in the Y direction the relative position between the nozzle hole 201 and the stage 31 when shaping an odd-numbered layer and when shaping an even-numbered layer. Therefore, a decrease in the strength of the three-dimensional shaped object OB1 can be prevented.

In addition, in the present embodiment, the position of the space SP in the odd-numbered shaping layer and the position of the space SP in the even-numbered shaping layer can be made different in the Y direction by the control unit 500 causing the position of the line head 200 to be moved in the Y direction. Therefore, the positions where the spaces SP occur in the three-dimensional shaped object OB1 can be prevented, by a simple configuration, from overlapping with each other in the lamination direction.

In addition, in the present embodiment, the control unit 500 causes the position of the line head 200 to be moved in the Y direction, and changes the nozzle holes 201, from which the droplets of the binding liquid are discharged, according to the distance to which the line head 200 is moved. Therefore, it is possible to prevent the deviation, accompanying the movement of the line head 200, of the end portion of the odd-numbered shaping layer and the end portion of the even-numbered shaping layer in the Y direction.

In addition, in the present embodiment, when forming an odd-numbered shaping layer, the binding liquid is discharged from the nozzle holes 201 of one head at the overlap portion OL, and when forming an even-numbered shaping layer, the binding liquid is discharged from the nozzle holes 201 of another head at the overlap portion OL. Therefore, the positions of the spaces SP occurring due to a positional deviation of the heads 210 to 240 at the overlap portion OL can be made different in the Y direction.

In addition, in the present embodiment, in the three-dimensional shaped object OB1 shaped by a binding agent injection system that discharges the binding liquid from the nozzle hole 201 onto the powder layer, the positions where the spaces SP occur can be prevented from overlapping with each other in the lamination direction.

In addition, in the present embodiment, a surface of the powder layer can be formed planar by the planarizing unit 112 implemented by the roller, and the thermosetting binding agent can be cured by the curing energy supply unit 130 implemented by the heater. Therefore, the three-dimensional shaped object OB1 shaped by the binding agent injection system can be shaped with high dimensional accuracy.

In addition, in the present embodiment, the three-dimensional shaped object OB1 containing a metal powder or a ceramic powder can be shaped by using the three-dimensional shaping device 10. Therefore, by performing a sintering processing on the three-dimensional shaped object OB1 after the shaping processing, the mechanical strength of the three-dimensional shaped object OB1 can be improved.

Powder-like stainless steel is used as the powder in the present embodiment, and alternatively, as described above, various materials such as a metal material, a ceramic material, a resin material, a composite material, wood, rubber, leather, carbon, glass, a biocompatible material, a magnetic material, gypsum, and sand can be used. A metal material or a ceramic material that can be subjected to a sintering processing after the three-dimensional shaped object OB1 is shaped is preferably used as the powder. This is because the mechanical strength of the three-dimensional shaped object OB1 can be improved by the sintering processing.

A steel material or a non-ferrous metal material may be used as the metal material. An alloy may be used as the metal material. One type of metal material may be used, or two or more types of metal materials may be used in combination. The metal material may be coated with, for example, a thermoplastic resin to be described below, or with another thermoplastic resin other than the thermoplastic resin. Examples of the metal material are shown below. It should be noted that the metal materials shown below are examples, the present disclosure is not limited thereto, and various metal materials can be used.

### Example of Metal Material

Single metals such as magnesium (Mg), aluminum (Al), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), palladium (Pd), silver (Ag), indium (In), tin (Sn), tantalum (Ta), tungsten (W), and neodymium (Nd), or an alloy containing one or more of these metals

### Example of Alloy

Maraging steel, stainless steel, cobalt chromium molybdenum, a titanium alloy, a nickel alloy, an aluminum alloy, a cobalt alloy, and a cobalt chromium alloy

A hydroxide ceramic or a non-hydroxide ceramic may be used as the ceramic material. One type of ceramic material may be used, or two or more types of ceramic materials may be used in combination. The ceramic material may be coated with, for example, a thermoplastic resin to be described below, or with another thermoplastic resin other than the thermoplastic resin. Examples of the ceramic material are shown below. It should be noted that the ceramic materials shown below are examples, the present disclosure is not limited thereto, and various ceramic materials can be used.

### Example of Ceramic Material

Oxide ceramics such as silicon dioxide, titanium dioxide, aluminum oxide or zirconium oxide, and non-oxide ceramics such as aluminum nitride, silicon nitride or silicon carbide

A thermoplastic resin or a thermosetting resin may be used as the resin material. One type of resin material may be used, or two or more types of resin materials may be used in combination. Examples of the resin material are shown below. It should be noted that the resin materials shown below are examples, the present disclosure is not limited thereto, and various resin materials can be used.

### Example of Thermoplastic Resin Material

General-purpose engineering plastics such as a polypropylene resin (PP), a polyethylene resin (PE), a polyacetal resin (POM), a polyvinyl chloride resin (PVC), a polyamide resin (PA), an acrylonitrile-butadiene-styrene resin (ABS), a polylactic acid resin (PLA), a polyphenylene sulfide resin (PPS), polycarbonate (PC), a modified polyphenylene ether, polybutylene terephthalate, or polyethylene terephthalate, and special engineering plastics such as polysulfone, polyether sulfone, polyphenylene sulfide, polyarylate, polyimide, polyamideimide, polyetherimide, or polyether ether ketone (PEEK)

### Example of Thermosetting Resin Material

A phenol resin (PF), an epoxy resin (EP), a melamine resin (MF), a urea resin (UF), an unsaturated polyester resin (UP), an alkyd resin, polyurethane (PUR), and thermosetting polyimide (PI)

The binding liquid may contain a solvent, various colorants such as a pigment or a dye, a dispersant, a surfactant, a polymerization initiator, a polymerization promoter, an infiltration promoter, a wetting agent (humectant), a fixing agent, an antifungal agent, a preservative, an antioxidant, an ultraviolet absorber, a chelating agent, a pH adjuster, a thickener, a filler, a deflocculating agent, a defoaming agent, or the like.

### Example of Solvent

Water, alkylene glycol monoalkyl ethers such as ethylene glycol monomethyl ether, ethylene glycol monoethyl ether, propylene glycol monomethyl ether or propylene glycol monoethyl ether, acetic acid esters such as ethyl acetate, n-propyl acetate, iso-propyl acetate, n-butyl acetate or iso-butyl acetate, aromatic hydrocarbons such as benzene, toluene or xylene, ketones such as methyl ethyl ketone, acetone, methyl isobutyl ketone, ethyl-n-butyl ketone, diisopropyl ketone or acetyl acetone, and alcohols such as ethanol, propanol or butanol, are used as the solvent. One type thereof may be used as the solvent, or two or more types thereof may be used in combination as the solvent.

### B. Second Embodiment

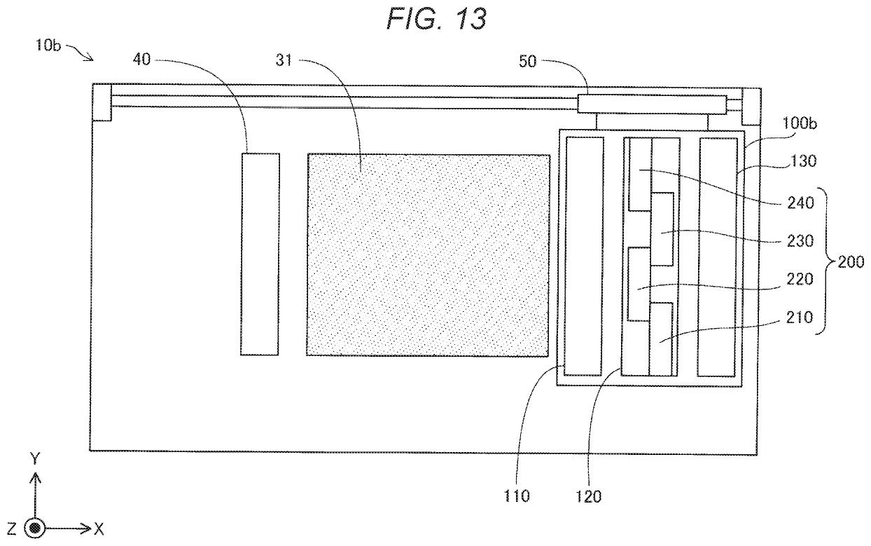

FIG. 13 is an illustrative diagram illustrating a schematic configuration of a three-dimensional shaping device 10b according to a second embodiment. FIG. 13 schematically illustrates the three-dimensional shaping device 10b as viewed from above. The second embodiment is different from the first embodiment in that a shaping unit 100b is not provided with the sub moving unit 125 in the three-dimensional shaping device 10b. Other configurations are the same as those of the first embodiment illustrated in FIGS. 1 and 2, unless otherwise specified.

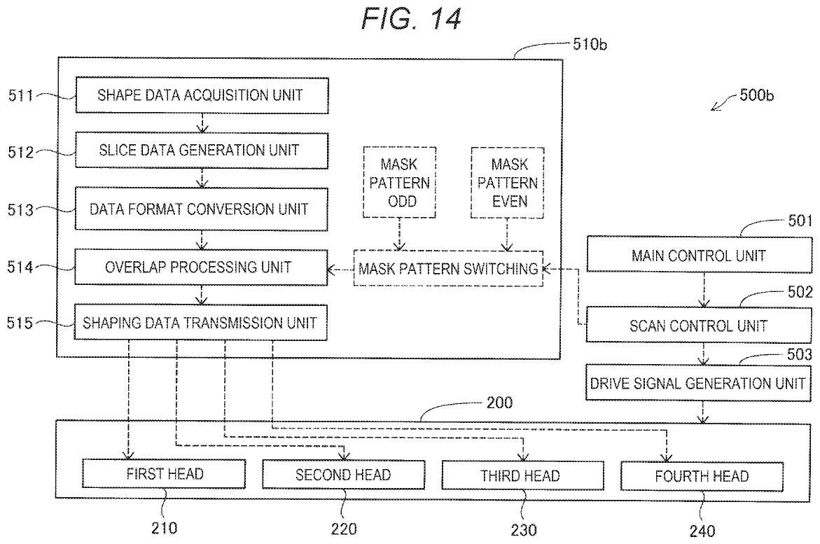

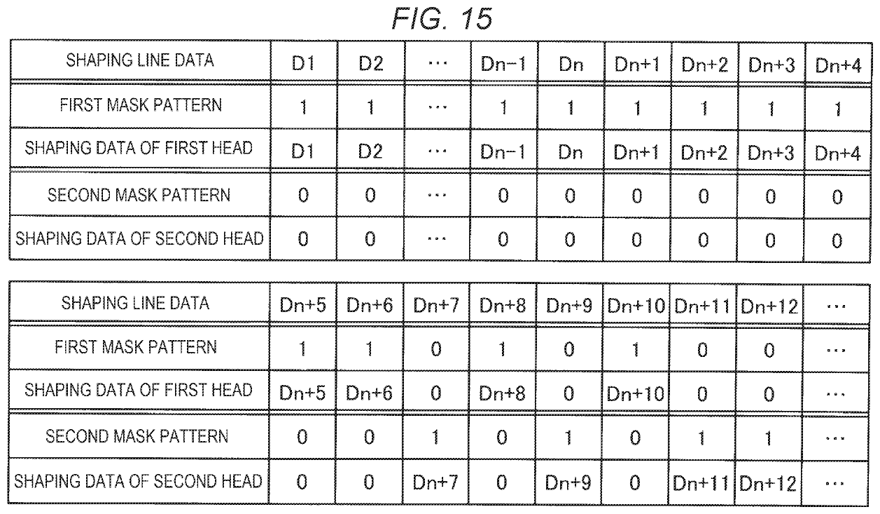

FIG. 14 is a block diagram illustrating a configuration of a control unit 500b according to the second embodiment. In a storage device of the control unit 500b, a mask pattern ODD and a mask pattern EVEN, which are two types of mask patterns, are stored in advance. The overlap processing unit 514 of a shaping data generation unit 510b uses the mask pattern ODD to perform an overlap processing when forming an odd-numbered shaping layer, and uses the mask pattern EVEN to perform an overlap processing when forming an even-numbered shaping layer.

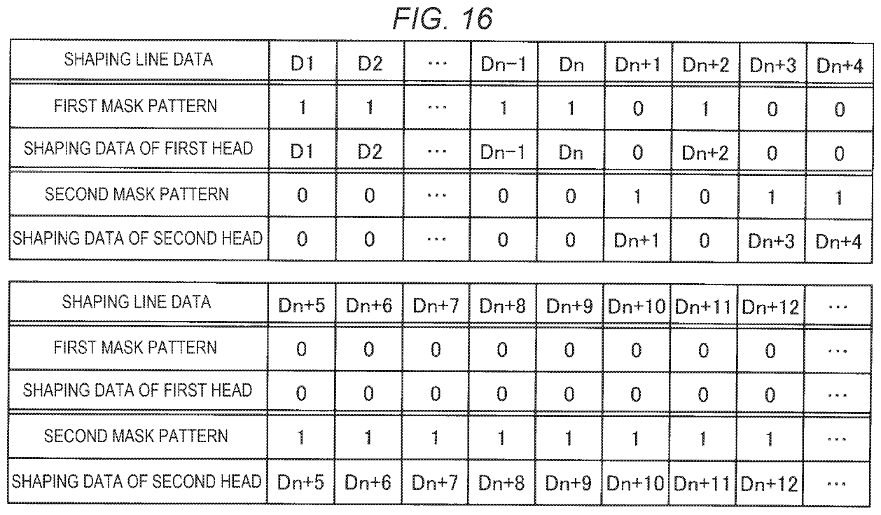

FIG. 15 is a first illustrative diagram illustrating a table for converting line data to shaping data according to the second embodiment. FIG. 16 is a second illustrative diagram illustrating the table for converting the line data to the shaping data according to the second embodiment. FIG. 15 illustrates an example of the shaping data generated by using both the line data and the mask pattern ODD. FIG. 16 illustrates an example of the shaping data generated by using both the line data and the mask pattern EVEN.

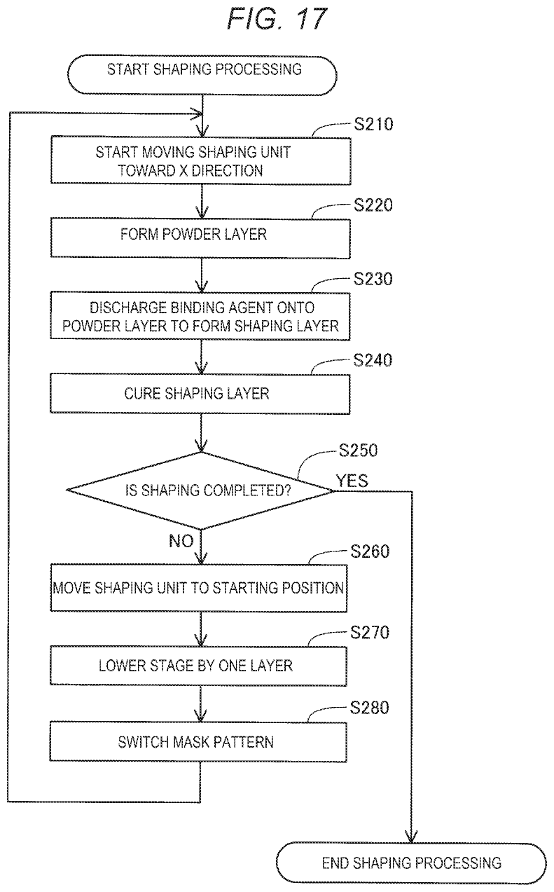

FIG. 17 is a flowchart illustrating contents of a shaping processing for realizing shaping of the three-dimensional shaped object OB1 according to the second embodiment. Since contents of the processing from step S210 to step S270 are the same as steps S110 to S170 described with reference to FIG. 6 in the first embodiment, the description thereof will be omitted. In the second embodiment, the control unit 500b, in step S280, switches the mask patterns for use in the overlap processing between the mask pattern ODD and the mask pattern EVEN, and then returns the processing to step S210 to form another shaping layer above the shaping layer. That is, the control unit 500b uses different mask patterns to cause the relative position between the nozzle hole 201, from which droplets are discharged, and the stage 31 to be changed in the Y direction, when forming an odd-numbered shaping layer and when forming an even-numbered shaping layer. Three or more types of mask patterns may be stored in the storage device of the control unit 500b, and the mask patterns may be switched each time one layer is formed.

According to the three-dimensional shaping device 10b of the present embodiment described above, the control unit 500b can switch the mask patterns to cause the relative position between the nozzle holes 201, which are at the overlap portion OL and from which droplets are discharged, and the stage 31 to be changed in the Y direction, when shaping an odd-numbered shaping layer and when shaping an even-numbered shaping layer. Therefore, it is possible to shape the three-dimensional shaped object OB1 in which the position of the space SP in the odd-numbered forming layer and the position of the space SP in the even-numbered forming layer are dispersed without overlapping with each other in the lamination direction. In particular, in the present embodiment, the positions where the spaces SP occur in the three-dimensional shaped object OB1 can be dispersed even when the line head 200 is not moved.

### C. Other Embodiments

(C1) In the three-dimensional shaping device 10 of the first embodiment described above, the control unit 500 causes the relative position between the line head 200 and the stage 31 to be changed in the Y direction when forming an odd-numbered shaping layer and when forming an even-numbered shaping layer. That is, the control unit 500 causes the relative position between the line head 200 and the stage 31 to be changed in the Y direction by one stage. On the other hand, the control unit 500 may cause the relative position between the line head 200 and the stage 31 to be changed in the Y direction by two or more stages. For example, the control unit 500 may cause the relative position between the line head 200 and the stage 31 to be changed in the Y direction when forming a first shaping layer and when forming a second shaping layer, and further causes the relative position between the line head 200 and the stage 31 to be changed in the Y direction when forming the second shaping layer and when forming a third shaping layer. In this case, the positions of the spaces SP in the three-dimensional shaped object OB1 can be further dispersed.

(C2) In the three-dimensional shaping device 10 of the first embodiment described above, when forming an odd-numbered shaping layer and when forming an even-numbered shaping layer, the control unit 500 causes the line head 200 to be moved in the Y direction by a distance equal to the length of the overlap portion OL, and changes the nozzle holes 201, from which droplets are discharged, to the nozzle holes 201 arranged in a direction opposite to the moving direction of the line head 200 and at a distance equal to the moving distance of the line head 200. On the other hand, when forming an odd-numbered shaping layer and when forming an even-numbered shaping layer, the control unit 500 may cause the line head 200 to be moved in the Y direction by a distance equal to a length obtained by multiplying an interval between the nozzle holes 201 by a natural number, and may change the nozzle hole 201, from which droplets are discharged, to the nozzle holes 201 arranged at a distance equal to the moving distance of the line head 200. In this case, it is possible to prevent the deviation, accompanying the movement of the line head 200, of the end portion of an odd-numbered shaping layer in the Y direction and the end portion of an even-numbered shaping in the Y direction, and it is possible to make the nozzle holes 201, from which droplets are discharged, different in the Y direction when forming an odd-numbered shaping layer and when forming an even-numbered shaping layer. Therefore, it is possible to make the discharge characteristics of the nozzle holes 201, from which droplets are discharged, different when forming an odd-numbered shaping layer and when forming an even-numbered shaping layer.

(C3) The three-dimensional shaping devices 10 and 10b of the embodiments described above shape one shaping layer above the stage 31 while the shaping units 100 and 100b reciprocate once above the stage 31 along the X direction. On the other hand, the three-dimensional shaping devices 10 and 10b may shape two shaping layers above the stage 31 while the shaping units 100 and 100b reciprocate once above the stage 31 along the X direction. For example, in the shaping unit 100 illustrated in FIG. 1, when the powder layer forming unit 110 is further provided at the left side of the discharge unit 120, and the curing energy supply unit 130 is further provided at the right side of the discharge unit 120, two shaping layers can be shaped above the stage 31 while the shaping unit 100 reciprocates once above the stage 31 along the X direction.

(C4) The three-dimensional shaping devices 10 and 10b of the embodiments described above are a binding agent injection system that shapes the three-dimensional shaped object OB1 by discharging droplets of the binding liquid from the nozzle holes 201. On the other hand, the three-dimensional shaping devices 10 and 10b may be a material injection system that shapes a three-dimensional shaped object by discharging droplets of a shaping liquid from the nozzle holes 201. The shaping liquid refers to a liquid containing a material of the three-dimensional shaped object. Various materials such as a particulate metal material, a particulate ceramic material, or a particulate resin material can be used as the material contained in the shaping liquid. In this case, the powder layer forming unit 110 may not be provided in the shaping units 100 and 100b.

A steel material or a non-ferrous metal material may be used as the metal material contained in the shaping liquid. An alloy may be used as the metal material. One type of metal material may be used, or two or more types of metal materials may be used in combination. The metal material may be coated with, for example, a thermoplastic resin to be described below, or with another thermoplastic resin other than the thermoplastic resin. Examples of the metal material are shown below. It should be noted that the metal materials shown below are examples, the present disclosure is not limited thereto, and various metal materials can be used.

### Example of Metal Material

Single metals such as magnesium (Mg), aluminum (Al), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), palladium (Pd), silver (Ag), indium (In), tin (Sn), tantalum (Ta), tungsten (W), and neodymium (Nd), or an alloy containing one or more of these metals

### Example of Alloy

Maraging steel, stainless steel, cobalt chromium molybdenum, a titanium alloy, a nickel alloy, an aluminum alloy, a cobalt alloy, and a cobalt chromium alloy

A hydroxide ceramic or a non-hydroxide ceramic may be used as the ceramic material contained in the shaping liquid. One type of ceramic material may be used, or two or more types of ceramic materials may be used in combination. The ceramic material may be coated with, for example, a thermoplastic resin to be described below, or with another thermoplastic resin other than the thermoplastic resin. Examples of the ceramic material are shown below. It should be noted that the ceramic materials shown below are examples, the present disclosure is not limited thereto, and various ceramic materials can be used.

### Example of Ceramic Material

Oxide ceramics such as silicon dioxide, titanium dioxide, aluminum oxide or zirconium oxide, and non-oxide ceramics such as aluminum nitride, silicon nitride or silicon carbide

A thermoplastic resin or a thermosetting resin may be used as the resin material contained in the shaping liquid. One type of resin material may be used, or two or more types of resin materials may be used in combination. Examples of the resin material are shown below. It should be noted that the resin materials shown below are examples, the present disclosure is not limited thereto, and various resin materials can be used.

### Example of Thermoplastic Resin Material

General-purpose engineering plastics such as a polypropylene resin (PP), a polyethylene resin (PE), a polyacetal resin (POM), a polyvinyl chloride resin (PVC), a polyamide resin (PA), an acrylonitrile-butadiene-styrene resin (ABS), a polylactic acid resin (PLA), a polyphenylene sulfide resin (PPS), polycarbonate (PC), a modified polyphenylene ether, polybutylene terephthalate, or polyethylene terephthalate, and special engineering plastics such as polysulfone, polyether sulfone, polyphenylene sulfide, polyarylate, polyimide, polyamideimide, polyetherimide, or polyether ether ketone (PEEK)

### Example of Thermosetting Resin Material

A phenol resin (PF), an epoxy resin (EP), a melamine resin (MF), a urea resin (UF), an unsaturated polyester resin (UP), an alkyd resin, polyurethane (PUR), and thermosetting polyimide (PI)

In addition, the shaping liquid may contain a solvent, various colorants such as a pigment or a dye, a dispersant, a surfactant, a polymerization initiator, a polymerization promoter, an infiltration promoter, a wetting agent (humectant), a fixing agent, an antifungal agent, a preservative, an antioxidant, an ultraviolet absorber, a chelating agent, a pH adjuster, a thickener, a filler, a deflocculating agent, a defoaming agent, or the like.

### Example of Solvent

Water, alkylene glycol monoalkyl ethers such as ethylene glycol monomethyl ether, ethylene glycol monoethyl ether, propylene glycol monomethyl ether or propylene glycol monoethyl ether, acetic acid esters such as ethyl acetate, n-propyl acetate, iso-propyl acetate, n-butyl acetate or iso-butyl acetate, aromatic hydrocarbons such as benzene, toluene or xylene, ketones such as methyl ethyl ketone, acetone, methyl isobutyl ketone, ethyl-n-butyl ketone, diisopropyl ketone or acetyl acetone, and alcohols such as ethanol, propanol or butanol, are used as the solvent. One type thereof may be used as the solvent, or two or more types thereof may be used in combination as the solvent

### D. Other Aspects

The present disclosure is not limited to the embodiments described above, and can be implemented in various forms without departing from the scope of the present disclosure. For example, the present disclosure can be implemented by the following forms. In order to solve some or all of the problems described in the present disclosure, or to achieve some or all of the effects of the present disclosure, the technical features of the embodiments describe above corresponding to the technical features described below of the embodiments can be replaced or combined as appropriate. In addition, unless described as essential herein, the technical features can be deleted as appropriate.

(1) According to a first aspect of the present disclosure, a three-dimensional shaping device is provided. The three-dimensional shaping device includes: a discharge unit in which a plurality of nozzles are arranged along a first direction and which discharges a liquid from the nozzles toward a stage; a main moving unit that changes a relative position between the discharge unit and the stage in a second direction intersecting the first direction; and a control unit that, while controlling the discharge unit and the main moving unit to change the relative position between the discharge unit and the stage along the second direction, repeats executing a processing of forming a shaping layer by discharging the liquid from the nozzle, to shape a laminated body in which the shaping layers are laminated. The control unit causes a relative position between the stage and the nozzle, from which the liquid is discharged, to be changed in the first direction when forming one layer of the shaping layers and when forming another layer of the shaping layers.

According to the three-dimensional shaping device of this aspect, since positions of spaces occurred in one shaping layer and positions of spaces occurred in another shaping layer can be made different in the first direction, the positions of the spaces in the laminated body in which the shaping layers are laminated can be prevented from overlapping with each other in the lamination direction. Therefore, a decrease in the strength of the three-dimensional shaped object shaped as a laminated body can be prevented.

(2) The three-dimensional shaping device of the above aspect includes a sub moving unit that changes the relative position between the discharge unit and the stage in the first direction, and the control unit causes the relative position between the stage and the nozzle, from which the liquid is discharged, to be changed in the first direction by controlling the sub moving unit to change in the first direction by a first distance the relative position between the discharge unit and the stage when forming one layer of the shaping layers and when forming another layer of the shaping layers.

According to the three-dimensional shaping device of this aspect, since the relative position between the discharge unit and the stage can be changed by the sub moving unit, the positions of the spaces occurred in one shaping layer and the positions of the spaces occurred in another shaping layer can be different in the first direction. Therefore, the positions where the spaces occur in the laminated body can be prevented, by a simple configuration, from overlapping with each other in the lamination direction.

(3) In the three-dimensional shaping device of the above aspect, the sub moving unit moves the relative position between the discharge unit and the stage in the first direction by moving the discharge unit, and the control unit controls the sub moving unit to move the discharge unit in the first direction by the first distance, and changes, among the plurality of nozzles, the nozzle from which the liquid is discharged to the nozzle that is arranged in a direction opposite to a moving direction of the discharge unit and at a second distance corresponding to the first distance.

According to the three-dimensional shaping device of this aspect, it is possible to prevent the deviation, accompanying movement of the discharge unit, of an end portion of one shaping layer and an end portion of another shaping layer in the first direction, and it is possible to made the positions of the spaces occurred in one shaping layer and the positions of the spaces occurred in another shaping layer different in the first direction.

(4) In the three-dimensional shaping device of the above aspect, the discharge unit includes a first head unit and a second head unit in which the plurality of nozzles are arranged, the first head unit and the second head unit are arranged along the first direction, with a portion of the first head unit and a portion of the second head unit overlapping with each other in the second direction; and by discharging the liquid from the nozzles of the first head unit in an overlapping region where the portion of the first head unit and the portion of the second head unit overlap with each other in the second direction when forming one layer of the shaping layers and by discharging the liquid from the nozzles of the second head in the overlapping region when forming another layer of the shaping layers, the control unit causes the relative position between the stage and the nozzle, from which the liquid is discharged, to be changed in the first direction when forming one layer of the shaping layers and when forming another layer of the shaping layers.

According to the three-dimensional shaping device of this aspect, since the liquid is discharged from the nozzles of the first head unit in the overlapping region when forming one shaping layer and the liquid is discharged from the nozzles of the second head unit in the overlapping region when forming another shaping layer, the positions of the spaces occurring due to a positional deviation between the head units in the overlapping region can be made different in the first direction.

(5) The three-dimensional shaping device of the above aspect includes a powder layer forming unit that supplies a powder onto the stage to form a powder layer, the discharge unit discharges the liquid containing a binding agent that binds the powders, and the control unit, by controlling the powder layer forming unit, the discharge unit and the main moving unit in the processing, forms the powder layer above the stage, and discharges the liquid containing the binding agent from the nozzle onto the powder layer while changing the relative position between the discharge unit and the stage along the second direction, so as to form the shaping layer.

According to the three-dimensional shaping device of this aspect, positions where spaces occur can be prevented from overlapping with each other in the lamination direction in the laminated body shaped by the binding agent injection system that discharges the liquid containing the binding agent from the nozzle onto the powder layer.

(6) The three-dimensional shaping device according to the above aspect includes a curing energy supply unit that supplies curing energy, which is for curing the binding agent, to the binding agent, and the powder layer forming unit includes a roller that planarizes the powder layer.

According to the three-dimensional shaping device of this aspect, a surface of the powder layer can be formed planar by the roller, and the binding agent contained in the shaping layer can be cured by the curing energy supply unit. Therefore, the laminated body can be shaped by the binding agent injection system with high dimensional accuracy.

(7) In the three-dimensional shaping device of the above aspect, the powder contains at least one of a metal powder and a ceramic powder.

According to the three-dimensional shaping device of this aspect, since a sintering processing can be performed on the laminated body after shaping, the mechanical strength of the laminated body can be improved.

(8) The three-dimensional shaping device of the above aspect includes: a discharge unit in which a plurality of nozzles are arranged along a first direction and which discharges a liquid from the nozzles toward a stage; a main moving unit that changes a relative position between the discharge unit and the stage in a second direction intersecting the first direction; a sub moving unit that moves the discharge unit in the first direction; and a control unit that, while controlling the discharge unit and the main moving unit to change the relative position between the discharge unit and the stage along the second direction, repeats executing a processing of forming a shaping layer by discharging the liquid from the nozzle, to shape a laminated body in which the shaping layers are laminated, and the control unit, when forming one layer of the shaping layers and when forming another layers of the shaping layer, controls the sub moving unit to move the discharge unit in the first direction by a distance equal to a multiple of an interval between adjacent nozzles, and changes, among the plurality of nozzles, the nozzle from which the liquid is discharged to the nozzle that is arranged in a direction opposite to a moving direction of the discharge unit and at the distance.

According to the three-dimensional shaping device of this aspect, it is possible to prevent the deviation, accompanying movement of the discharge unit, of an end portion of one shaping layer and an end portion of another shaping layer in the first direction, and it is possible to make the nozzles from which the liquid is discharged different in the first direction when forming one shaping layer and when forming another shaping layer. Therefore, discharge characteristics of the nozzles from which the liquid is discharged can be made different when forming one shaping layer and when forming another shaping layer.

The present disclosure may be implemented in various forms other than the three-dimensional shaping device. For example, the present disclosure can be implemented in the form of a shaping method for the three-dimensional shaped object, or the like.

What is claimed is:

1. A three-dimensional shaping device, comprising:
a discharge unit in which a plurality of nozzles are arranged along a first direction and which discharges a liquid from the nozzles toward a stage;
a main moving unit that changes a relative position between the discharge unit and the stage in a second direction intersecting the first direction; and
a control unit that, while controlling the discharge unit and the main moving unit to change the relative position between the discharge unit and the stage along the second direction, repeats executing a processing of forming a shaping layer by discharging the liquid from the nozzle, to shape a laminated body in which the shaping layers are laminated, wherein
the control unit causes a relative position between the stage and the nozzle, from which the liquid is discharged, to be changed in the first direction when forming one layer of the shaping layers and when forming another layer of the shaping layers.

2. The three-dimensional shaping device according to claim 1, further comprising:
a sub moving unit that changes the relative position between the discharge unit and the stage in the first direction, wherein
the control unit causes the relative position between the stage and the nozzle, from which the liquid is discharged, to be changed in the first direction by controlling the sub moving unit to change in the first direction by a first distance the relative position between the discharge unit and the stage when forming one layer of the shaping layers and when forming another layer of the shaping layers.

3. The three-dimensional shaping device according to claim 2, wherein
the sub moving unit changes the relative position between the discharge unit and the stage in the first direction by moving the discharge unit, and
the control unit
controls the sub moving unit to move the discharge unit in the first direction by the first distance, and
changes, among the plurality of nozzles, the nozzle from which the liquid is discharged to the nozzle that is arranged in a direction opposite to a moving direction of the discharge unit at a second distance corresponding to the first distance.

4. The three-dimensional shaping device according to claim 1, wherein
the discharge unit includes a first head unit and a second head unit in which the plurality of nozzles are arranged, and the first head unit and the second head unit are arranged along the first direction, with a portion of the first head unit and a portion of the second head unit overlapping with each other in the second direction, and
by discharging the liquid from the nozzles of the first head unit in an overlapping region where the portion of the first head unit and the portion of the second head unit overlap with each other in the second direction when forming one layer of shaping layers and by discharging the liquid from the nozzles of the second head in the overlapping region when forming another layer of the shaping layers, the control unit causes the relative position between the stage and the nozzle, from which the liquid is discharged, to be changed in the first direction when forming one layer of the shaping layers and when forming another layer of the shaping layers.

5. The three-dimensional shaping device according to claim 1, further comprising:
a powder layer forming unit that supplies a powder onto the stage to form a powder layer, wherein
the discharge unit discharges the liquid containing a binding agent that binds the powders, and
the control unit, by controlling the powder layer forming unit, the discharge unit and the main moving unit in the processing, forms the powder layer above the stage, and discharges the liquid containing the binding agent from the nozzle onto the powder layer while changing the relative position between the discharge unit and the stage along the second direction, so as to form the shaping layer.

6. The three-dimensional shaping device according to claim 5, further comprising:
a curing energy supply unit that supplies curing energy, which is for curing the binding agent, to the binding agent, wherein
the powder layer forming unit includes a roller that planarizes the powder layer.

7. The three-dimensional shaping device according to claim 5, wherein
the powder contains at least one of a metal powder and a ceramic powder.

8. A three-dimensional shaping device, comprising:
a discharge unit in which a plurality of nozzles are arranged along a first direction and which discharges a liquid from the nozzles toward a stage;
a main moving unit that changes a relative position between the discharge unit and the stage in a second direction intersecting the first direction;
a sub moving unit that moves the discharge unit in the first direction; and
a control unit that, while controlling the discharge unit and the main moving unit to change the relative position between the discharge unit and the stage along the second direction, repeats executing processing of forming a shaping layer by discharging the liquid from the nozzle, to shape a laminated body in which the shaping layers are laminated, wherein
the control unit
when forming one layer of the shaping layers and when forming another layer of the shaping layers, controls the sub moving unit to move the discharge unit in the first direction by a distance equal to a multiple of an interval between adjacent nozzles, and
changes, among the plurality of nozzles, the nozzle from which the liquid is discharged to the nozzle that is arranged in a direction opposite to a moving direction of the discharge unit and at the distance.

9. A shaping method for a three-dimensional shaped object, comprising:
forming a shaping layer by discharging a liquid from a plurality of nozzles, which are arranged along a first direction, toward a stage while changing a relative position between the nozzles and the stage in a second direction intersecting the first direction; and
repeatedly performing formation of the shaping layer to shape a laminated body in which the shaping layers are laminated, wherein
the relative position between the stage and the nozzles, from which the liquid is discharged, is changed in the first direction when forming one layer of the shaping layers and when forming another layer of the shaping layers.
